(19) United States
(12) Patent Application Publication
(10) Pub. No.: US 2013/0220110 A1
(43) Pub. Date: Aug. 29, 2013

(54) VEHICLE BODY INCLINATION-ANGLE REGULATING UINT, HYDROPNEUMATIC SUSPENSION MECHANISM AND MOBILE CRANE

(71) Applicants: Chunxin Zhan, Changsha (CN); Quan Liu, Changsha (CN); Yi Li, Changsha (CN); Yingzhi Li, Changsha (CN); Qitao Wang, Changsha (CN)

(72) Inventors: Chunxin Zhan, Changsha (CN); Quan Liu, Changsha (CN); Yi Li, Changsha (CN); Yingzhi Li, Changsha (CN); Qitao Wang, Changsha (CN)

(73) Assignees: Zoomlion Heavy Industry Science and Technology Co., Ltd., Changsha (CN); HUNAN ZOOMLION SPECIAL VEHICLE CO., LTD., Changde (CN)

(21) Appl. No.: 13/704,198

(22) PCT Filed: May 18, 2011
(86) PCT No.: PCT/CN2011/074259

§ 371 Date: May 9, 2013

(30) Foreign Application Priority Data
Jun. 13, 2010 (CN) 201010207621.9

(51) Int. Cl. F15B 15/00

(52) U.S. Cl. CPC F15B 15/00
USPC 91/459

(57) ABSTRACT

A vehicle body inclination angle regulating unit (17) includes a balancing oil cylinder (10). One chamber of the balancing oil cylinder (10) is connected with an oil tank (5) and an oil source for leveling operation via a first one-way damper valve (8) and an electric controlled switch valve (7), and the other chamber of the balancing oil cylinder (10) is connected with a non-rod chamber of a suspension oil cylinder via an electric controlled shutoff valve (14) and a second one-way damper valve (9). In addition, an automatically-leveling hydropneumatic suspension mechanism includes at least two pairs of suspension oil cylinders (12), vehicle body inclination angle regulating units (17), a vehicle body transverse inclination angle sensor (1) and a control unit (3). Each suspension oil cylinder (12) is correspondingly provided with the vehicle body inclination angle regulating unit (17) including the balancing oil cylinder (10). The present invention realizes effectively dynamic leveling function of different road conditions, especially transverse slopes, of the mobile crane. The mobile crane is provided with simple operation that are all automatically performed by the control unit, which improves driving safety remarkably and prevents an accident of vehicle overturning.

### TECHNICAL FIELD

The present invention relates to a vehicle body inclination angle regulating unit and an automatically-leveling hydropneumatic suspension mechanism. Moreover, the present invention relates to a mobile crane that includes the automatically-leveling hydropneumatic suspension mechanism.

### BACKGROUND

Mobile crane usually refers to a hoisting crane that can move freely on the ground, typically a hoisting cranes mounted on an engineering vehicle. Mobile cranes are widely applied in the engineering machinery domain, due to their mobility and adaptability. For large-tonnage or super-large-tonnage mobile cranes, especially for all-terrain cranes, the hydropneumatic suspension mechanism must have the following functions: ascending and descending of suspension mechanism, switching between rigid state and elastic state, loading under traveling condition, shock absorption, and self-adaptation to road conditions, etc., so as to meet the requirement for mobile crane operation under different conditions.

Hydropneumatic suspension mechanisms pertain to a new chassis suspension technique originally invented in 1960s. In regard to the main working principle of a hydropneumatic suspension mechanism, the hydropneumatic suspension mechanism converts the vertical axle load of an engineering machine (e.g., a mobile crane) into oil pressure in suspension oil cylinders, the pressure is transferred through pipelines to the corresponding control units and hydraulic accumulators, the hydraulic accumulators utilize an inert gas (for example, nitrogen) having an initial pressure as an elastic medium, and control the oil flow direction or throttling by means of the corresponding one-way valves and throttling orifices in the oil pipelines, so as to achieve a damping effect. Accordingly, the hydropneumatic suspension mechanism mainly comprises suspension oil cylinders, hydraulic accumulators, suspension valves, and corresponding control elements. Hydropneumatic suspension mechanisms are widely applied in various engineering machines, such as wheeled loaders, Mine dump trucks, wheeled diggers, and mobile cranes (typically all-terrain cranes), etc., due to their significant advantage in improving the running smoothness of engineering machines.

Generally speaking, mobile cranes should run with the vehicle frame and body kept in a level state to prevent overturning accidents, because of their high gravity center and huge weight. However, since mobile cranes not always run on level roads with good road conditions, but often run on roads with harsh road conditions (e.g., on longitudinal or transverse slope roads), the vehicle frame and body will have an inclination angle in longitudinal or transverse direction due to the road slope when the mobile crane runs on such the harsh road. In that case, overturning accidents may occur easily. Under the harsh road conditions, the hydropneumatic suspension mechanism of mobile crane is required to be able to automatically adjust the position of vehicle frame and body, so as to keep the vehicle frame and body in level state. The function is the road condition self-adapting function of hydropneumatic suspension mechanism of mobile crane. The automatically-leveling capability of hydropneumatic suspension mechanism takes an important role in implementation of the road condition self-adapting function.

The hydropneumatic suspension mechanisms built in existing mobile cranes are mainly designed for running under good road conditions. In contrast, hydropneumatic suspension mechanisms that can adapt to harsh road conditions, especially transverse slope road conditions, are only under research by very few manufacturers or scientific institutions at present, and no practical application of such hydropneumatic suspension mechanisms has been found. In addition, in Chinese Utility Model Patent No. CN2649377Y, a hydropneumatic suspension mechanism of mobile crane is disclosed. The hydropneumatic suspension mechanism is mainly used for a manual or electric-controlled static leveling operation under transverse slope or longitudinal slope conditions when the vehicle is in static state. Specifically, the hydropneumatic suspension mechanism usually utilizes suspension valves to input or output oil, so as to regulate the lifting height of suspension oil cylinders and thereby achieve static regulation. However, it is more important to achieve dynamically leveling operations while the mobile crane is running. In addition, the hydropneumatic suspension mechanism disclosed in the Chinese Utility Model Patent No. CN2649377Y implements leveling operations mainly by means of oil supply or return compensation. However, under dynamic running conditions, it is impossible to control the oil compensation amount, and therefore dynamically leveling operations on the foresaid mobile crane can't be implemented while the mobile crane is running. Especially, it is unable to achieve true dynamically self-adaptation leveling capability for transverse slope roads of the hydropneumatic suspension mechanism of mobile crane.

In view of above problems, there is a need for a novel automatically-leveling hydropneumatic suspension mechanism, which can dynamically accomplish automatically-leveling operations on mobile cranes or other mobile engineering machines under different harsh road conditions, especially under transverse slope conditions.

### SUMMARY OF THE INVENTION

One technical problem solved by the present invention is to provide a vehicle body inclination angle regulating unit, which can be applied in hydropneumatic suspension mechanisms to achieve dynamically and automatically leveling operation of the hydropneumatic suspension mechanism.

Another technical problem solved by the present invention is to provide an automatically-leveling hydropneumatic suspension mechanism, which can dynamically accomplish automatically leveling operations against transverse slope when the mobile engineering machines run on transverse slope roads, and thereby effectively prevent severe accidents such as vehicle-overturning that are often seen among existing mobile engineering machines due to the insensitivity of the hydropneumatic suspension mechanism to transverse slopes, and effectively improve the safety of mobile engineering machines.

In addition, the present invention is to provide a mobile crane, which includes a hydropneumatic suspension mechanism that has high dynamically and automatically leveling performance against transverse slopes, and thereby can effectively prevent vehicle over-turning accidents often seen among existing mobile cranes due to the insensitivity of the hydropneumatic suspension mechanism to transverse slopes.

To solve the first technical problem described above, the present invention provides a vehicle body inclination angle regulating unit, wherein, it comprises a balancing oil cylinder, one chamber of the balancing oil cylinder being connected to an electric controlled switch valve by a hydraulic pipeline provided with a first one-way damper valve, and the other chamber of the balancing oil cylinder being connected to a second one-way damper valve by a hydraulic pipeline provided with an electric controlled shutoff valve, so that the oil way to the non-spring chamber of the balancing oil cylinder being selectively communicated or shut by the electric controlled shutoff valve.

To solve the second technical problem described above, the present invention provides an automatically-leveling hydropneumatic suspension mechanism, comprising at least two pairs of suspension oil cylinders, each pair of which are arranged on the left and right sides of the corresponding vehicle bridge respectively, wherein, the automatically-leveling hydropneumatic suspension mechanism further comprises: vehicle body inclination angle regulating units, each of the suspension oil cylinder being correspondingly connected with one of vehicle body inclination angle regulating units, each of the vehicle body inclination angle regulating units designed to control a cylinder rod of the corresponding suspension oil cylinder to extend or retract; a vehicle body transverse inclination angle sensor, designed to detect the transverse inclination angle of vehicle body; and a control unit, which receives the signal of transverse inclination angle of vehicle body sent by the vehicle body transverse inclination angle sensor and is connected with an oil source for leveling operation and the vehicle body inclination angle regulating unit through electric control circuits.

Furthermore, the present invention provides a mobile crane, which comprises the automatically-leveling hydropneumatic suspension mechanism described above.

In the above-described technical solutions according to the present invention, the automatically-leveling hydropneumatic suspension mechanism provided in the present invention can utilize the control unit to select a specific control mode among predefined vehicle body inclination angle control modes according to the vehicle body inclination angle signal (preferably including the signal of axle load pressure on the suspension mechanism), and control the vehicle body inclination angle regulating units, so that the hydropneumatic suspension mechanism can keep the vehicle body in level state; then, the control unit can continuously and automatically keep the vehicle body in a specific attitude or switch among vehicle body attitudes according to the signal after the leveling operation, and thereby achieving automatically and dynamically leveling of a mobile engineering machine (e.g., a mobile crane) under different road conditions, especially under transverse slope conditions. When the automatically-leveling hydropneumatic suspension mechanism according to the present invention keeps the vehicle body in a specific attitude or switch among vehicle body attitudes, it utilizes a stable oil source for leveling operation (preferably a constant pressure oil source) to supply power, so as to extrude the hydraulic oil out of the balancing oil cylinders or seal the hydraulic oil in the balancing oil cylinders, and thereby automatically keep constant oil quantity in the hydropneumatic suspension mechanism and keep a balance between left and right axle loads, to ensure smooth automatically-leveling operation of the mobile crane and effectively ensure safety of the mobile crane. The automatically-leveling hydropneumatic suspension mechanism according to the present invention effectively implements dynamically and automatically leveling capability of a mobile engineering machine (e.g., a mobile crane) against different road conditions, especially dynamically and automatically leveling capability against transverse slopes; in addition, the automatically-leveling hydropneumatic suspension mechanism according to the present invention is easy to operate and logically reasonable; since all operations are accomplished automatically by the control unit, the automatically-leveling hydropneumatic suspension mechanism is safe and reliable to use, and significantly improves safety of vehicle running on a transverse slope road, and thereby it can prevent severe accidents such as vehicle-overturning. Other characteristics and advantages of the present invention will be further detailed in the embodiments hereunder.

### DESCRIPTION OF ACCOMPANYING DRAWINGS

The accompanying drawings are provided to facilitate further understanding of the present invention, and constitute a part of the description. These drawings are used in conjunction with the embodiments to interpret the present invention, but don't constitute any limitation to the present invention. Among the drawings:

FIG. 1 is a schematic diagram showing the hinged connection between a suspension oil cylinder and the vehicle frame or vehicle body of a mobile crane;

FIG. 2 is a schematic diagram of a mobile crane running on a transverse slope road;

FIG. 3 is a block diagram showing control principle of the automatically-leveling hydropneumatic suspension mechanism according to an embodiment of the present invention;

FIG. 4 is a structural block diagram showing the arrangement structure of the vehicle body inclination angle regulating unit according to an embodiment of the present invention;

FIG. 5 is a hydraulic principle diagram of the vehicle body inclination angle regulating unit shown in FIG. 4;

FIG. 6 is a structural block diagram showing an overall arrangement of the automatically-leveling hydropneumatic suspension mechanism according to an embodiment of the present invention, wherein, the bold lines represent hydraulic pipelines, while the thin lines represent electric control wires or signal wires;

FIG. 7 is a schematic diagram showing the connection relation among the suspension oil cylinders, suspension valves, and hydraulic accumulators in the present invention;

FIG. 8 is a hydraulic system principle diagram of the automatically-leveling hydropneumatic suspension mechanism shown in FIG. 6.

### BRIEF DESCRIPTION OF REFERENCE NUMBERS IN THE ACCOMPANYING DRAWINGS

1 vehicle body transverse inclination angle sensor;

2 pressure oil source;

3 control unit;

4 constant pressure oil source,

5 oil tank;

6 vehicle body longitudinal inclination angle sensor;

7 electric controlled switch valve;

8 first one-way damper valve;

9 second one-way damper valve;

10 balancing oil cylinder (spring-returning oil cylinder);

11 hydraulic accumulator;

12 suspension oil cylinder;

13 suspension valve;

14 electric controlled shutoff valve,

15 vehicle frame;

16 vehicle bridge;

17 vehicle body inclination angle regulating unit;

18 suspension mechanism pressure sensor;

19 suspension oil cylinder's rigid and elastic state control valve;

20 suspension oil cylinder extension control valve;

21 suspension oil cylinder retraction control valve;

### DETAILED DESCRIPTION OF THE EMBODIMENTS

Hereunder the embodiments of the present invention will be detailed, with reference to the accompanying drawings. It should be appreciated that the embodiments described here are only provided to describe and explain the present invention, but shall not be deemed as constituting any limitation to the present invention.

Hydropneumatic suspension mechanisms are widely applied in various engineering machines, such as wheeled loaders, Mine dump trucks, wheeled diggers, and mobile cranes (typically all-terrain cranes). Therefore, the application of the automatically-leveling hydropneumatic suspension mechanism to be described below in the present invention is not limited to any specific engineering machine; instead, the automatically-leveling hydropneumatic suspension mechanism is applicable to various mobile engineering machines which can accomplish the application object of the present invention, such as mobile cranes. For convenience of description, hereunder the present invention will be described in the case of mobile cranes.

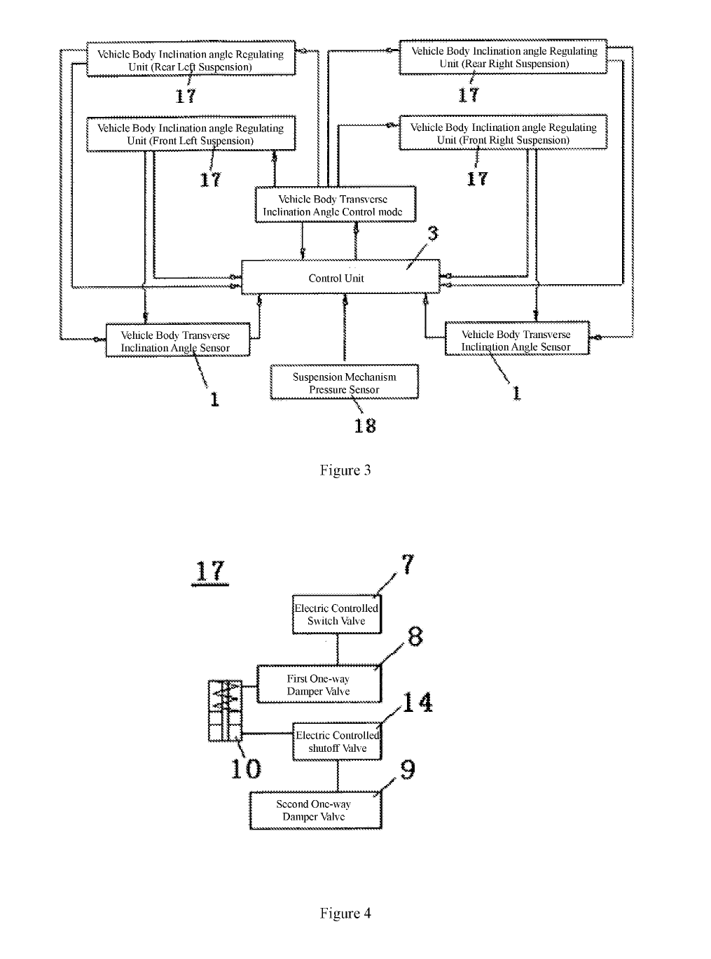

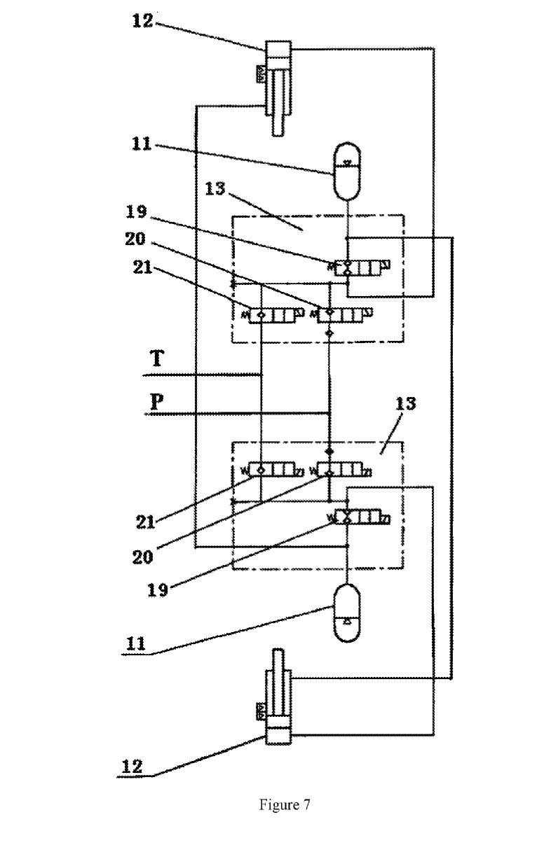

Please see FIG. 6. The automatically-leveling hydropneumatic suspension mechanism in an embodiment of the present invention mainly comprises suspension oil cylinders 12, hydraulic accumulators 11, suspension valves 13, a pressure oil source 2, a vehicle body transverse inclination angle sensor 1, an oil source for leveling operation (preferably a constant pressure oil source 4), vehicle body inclination angle regulating units 17, and a control unit 3. In a preferred embodiment, in order to implement automatically-leveling capability for longitudinal slopes, the automatically-leveling hydropneumatic suspension mechanism in the present invention further comprises a vehicle body longitudinal inclination angle sensor 6. Moreover, the automatically-leveling hydropneumatic suspension mechanism in the present invention can further comprises a suspension mechanism pressure sensor 18 (see FIG. 3), so that the control unit 3 can operate according to more signal values, and thereby improving the reliability of operation and detection.

To make the automatically-leveling hydropneumatic suspension mechanism in the present invention understood more clearly, hereunder the mechanical connection structure of the suspension oil cylinders 12 of the automatically-leveling hydropneumatic suspension mechanism and its function in automatically-leveling operation will be described first.

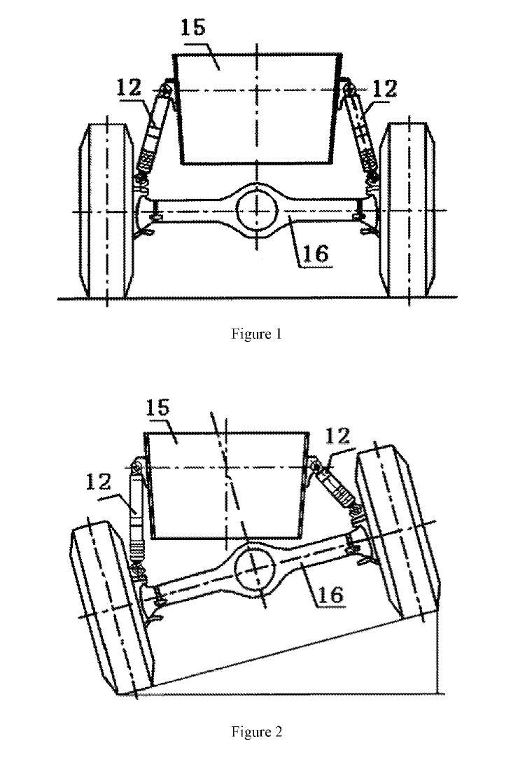

Please see FIG. 1. The suspension oil cylinders 12 are provided between the vehicle frame 15 and the vehicle bridge 16 (i.e., vehicle axle or axle), specifically, the suspension oil cylinders 12 are mounted between frame side rail of vehicle frame and the vehicle bridge 16, the upper end of the suspension oil cylinders 12 is hinged to the vehicle frame 15, and the lower end of the suspension oil cylinders 12 is hinged to the vehicle bridge 16. The upper end of each suspension oil cylinder 12 is usually hinged to the vehicle frame 15, however, for some special engineering machines, it can be directly hinged to the vehicle body. For example, for some Mine dump trucks that have a frameless vehicle body without vehicle frame, the upper end of each suspension oil cylinder 12 can be directly hinged to the vehicle body. Apparently, the suspension oil cylinders 12 are mounted symmetrically in relation to the longitudinal central axis of the mobile crane. for twin-axle mobile cranes, four suspension oil cylinders 12 are usually mounted; and for multi-axle mobile cranes, more suspension oil cylinders 12 are mounted, which is to say, on both sides of each vehicle bridge there mounted symmetrically with suspension oil cylinders 12. In addition, it is noted that the suspension oil cylinders 12 described here are mainly designed to bear vertical axle load of the mobile crane. Besides the suspension oil cylinders 12, the hydropneumatic suspension mechanism usually further comprises a plurality of guiding thrust rods, which are mainly designed to bear lateral force and traction force. Since the guiding thrust rods are not directly related with the automatically-leveling capability of the present invention, they will not be further described here any more.

The suspension oil cylinders 12 take an important role in the leveling operation of vehicle frame or vehicle body of mobile crane. In principle, the vehicle frame or vehicle body of mobile crane can be lifted up or lowered down by operating the suspension oil cylinders 12. Please see FIG. 2. When a mobile crane is on a transverse slope road, if the suspension oil cylinders 12 are not controlled and regulated, the vehicle frame or vehicle body of the mobile crane will incline to the left side as shown in FIG. 2 due to the transverse slope, which makes the mobile crane easy to overturn. To keep the vehicle frame 15 and vehicle body of the mobile crane in level state when the mobile crane runs on a transverse slope road, the suspension oil cylinders 12 on the left should be controlled to ascend, while the suspension oil cylinders 12 on the right should be controlled to descend, as shown in FIG. 2, so that the vehicle frame 15 and vehicle body of the mobile crane are kept in level or essentially level state, and thereby effectively preventing the mobile crane from overturning towards a side. Furthermore, though not shown in the figures, it is easy to conceive that the vehicle frame 15 and vehicle body of the mobile crane will be in a state that the front part is higher than the rear part or the front part is lower than the rear part when the mobile crane runs on a longitudinal slope road, owing to the longitudinal slope. Under this condition, to prevent the mobile crane from overturn forwards or backwards, the suspension oil cylinders 12 at the front vehicle bridge and/or rear vehicle bridge of the mobile crane should be regulated accordingly, so as to keep the vehicle frame 15 or vehicle body of the mobile crane in level state.

Hereunder the control principle of the automatically-leveling hydropneumatic suspension mechanism in the present invention will be described.

As described above, the hydropneumatic suspension mechanism comprises appropriate control elements (e.g., vehicle body transverse inclination angle sensor 1, suspension mechanism pressure sensor 18, vehicle body inclination angle regulating units 17, and control unit 3, etc.), which are mainly used to control the working states of the suspension oil cylinders 12. A basic function that should be implemented by the automatically-leveling hydropneumatic suspension mechanism in the present invention is: when a mobile engineering machine (e.g., a mobile crane) runs on a transverse slope road, the hydropneumatic suspension mechanism can dynamically and automatically accomplish leveling operation against the transverse slope. Of course, besides the basic function, in a more preferred embodiment to be described below according to the present invention, the automatically-leveling system in the present invention also has dynamically and automatically leveling capability against longitudinal slopes. On that basis, by combining the automatically leveling capability against transverse slopes and automatically leveling capability against longitudinal slopes, the mobile engineering machine (e.g., mobile crane) can adapt to various harsh road conditions.

To implement the basic function of automatically-leveling system described above in the present invention, i.e., to enable the hydropneumatic suspension mechanism to accomplish dynamically and automatically leveling operation when the mobile engineering machine (e.g., a mobile crane) runs on a transverse slope road, the automatically-leveling hydropneumatic suspension mechanism in the present invention comprises a plurality of vehicle body inclination angle regulating units 17, a vehicle body transverse inclination angle sensor 1, and a control unit 3, wherein, each vehicle body inclination angle regulating unit 17 is used to operate a suspension oil cylinder 12 correspondingly, i.e., the vehicle body inclination angle regulating units 17 are in the same quantity as the suspension oil cylinders 9. FIG. 3 is a block diagram showing control principle of the automatically-leveling hydropneumatic suspension mechanism in the present invention. In FIG. 3, the control principle of the automatically-leveling hydropneumatic suspension mechanism in the present invention is illustrated in an example of a twin-axle mobile crane, which is to say, for a twin-axle mobile crane, suspension oil cylinders 12 are mounted in symmetry on both sides of each vehicle bridge 16; accordingly, the vehicle body inclination angle regulating units 17 shown in FIG. 3 correspond to the front left suspension oil cylinder, front right suspension oil cylinder, rear left suspension oil cylinder and rear right suspension oil cylinder respectively, so as to control the extension/retraction of corresponding suspension oil cylinders.

Please see FIG. 3. The vehicle body transverse inclination angle sensor 1 detects the transverse inclination angle of vehicle body, the suspension mechanism pressure sensor 18 senses the axle load pressure on the suspension mechanism, and the vehicle body transverse inclination angle sensor 1 and suspension mechanism pressure sensor 18 transmit the signals of transverse inclination angle of vehicle body and axle load pressure on the suspension mechanism to the control unit 3 (e.g., a PLC or a microcomputer-based control unit) respectively; then the control unit 3 carries out judgment on the basis of the signal of transverse inclination angle of vehicle body and signal of axle load pressure on the suspension mechanism, and selects the vehicle body transverse inclination angle control mode among various preset vehicle body inclination angle control modes, performs analysis and calculation via the software module corresponding to the transverse inclination angle control mode for vehicle body, and then outputs a control signal to the corresponding vehicle body inclination angle regulating unit 17 so as to control the vehicle body inclination angle regulating unit 17; the vehicle body inclination angle regulating unit 17 controls the corresponding suspension oil cylinder 12 to extend or retract, and thereby ensures that the hydropneumatic suspension mechanism keeps the vehicle body in level or essentially level state. As the running state of the mobile crane on the transverse slope road changes, the control unit 3 (e.g., PLC or microcomputer-based control unit) will keep or change the vehicle body position continuously according to the subsequent signals after one vehicle body leveling operation, and thereby dynamically accomplishing the automatically leveling function of the hydropneumatic leveling suspension mechanism. Moreover, it is important to note here that the approach of simultaneous signal transmission from the vehicle body transverse inclination angle sensor 1 and suspension mechanism pressure sensor 18 described above is only a preferred embodiment of the present invention. In the automatically-leveling hydropneumatic suspension mechanism of the present invention, the control unit 3 can effectively accomplish automatically-leveling operation only on the basis of the signal of transverse inclination angle of vehicle body transmitted from the vehicle body transverse inclination angle sensor 1; of course, with the suspension mechanism pressure sensor 18 transmitting the axle load pressure signal simultaneously, the control unit 3 can carry out analysis, calculation, detection and operation on the basis of more parameter values, and thereby the operating reliability can be improved.

The vehicle body inclination angle control mode described above mainly refers to a corresponding control mode that is selected according to the graded settings based on transverse slope and longitudinal slope of road and/or the difference between left and right axle loads of the mobile crane and the difference between front and rear axle loads of the mobile crane in the dynamic running process of the mobile crane, each vehicle body inclination angle control mode has a corresponding software module (e.g., a user program in a programmable logic controller (PLC)). For example, the vehicle body transverse inclination angle sensor 1 transmits the current transverse inclination angle of vehicle body to the control unit 3 (e.g., a PLC), and the transverse inclination angle of vehicle body reaches to a preset value. Usually, the preset value of a mobile crane changes or varies depending on the different types or sizes of mobile cranes; the mobile crane will be in the risk of over-turning once the preset value is exceeded, and therefore regulation is required in that case; however, no regulation is required when the preset value is not exceeded. Such an arrangement can prevent the hydropneumatic suspension mechanism from carrying out unnecessary regulations frequently. The preset value is usually an empirical value or a conservative value, usually smaller than the limit value that will result in over-turning of the mobile crane (i.e., the preset value has a safety factor relative to the overturning limit value), and the preset value changes or varies depending on the different types or sizes of mobile cranes; usually, the preset value is determined on a premise that it can ensure safety of the mobile crane.

For example, when the transverse inclination angle of vehicle body is greater than the present value of transverse inclination angle of vehicle body, the vehicle body of the mobile crane must be leveled in transverse direction, otherwise the mobile crane may overturn in transverse direction. Accordingly, according to the input signal of transverse inclination angle (preferably including left and right axle load signal), the control unit 3 selects the built-in software module corresponding to the vehicle body transverse inclination angle control mode to control, and then the automatically-leveling hydropneumatic suspension mechanism in the present invention begins the automatically and dynamically leveling operation against transverse slope, so as to keep the vehicle body and vehicle frame of the mobile engineering machine (e.g., a mobile crane) in level or essentially level state, when the mobile engineering machine runs on a transverse slope road.

As described above, the automatically-leveling hydropneumatic suspension mechanism in an embodiment of the present invention comprises suspension oil cylinders 12, hydraulic accumulators 11, suspension valves 13, a pressure oil source 2, a vehicle body transverse inclination angle sensor 1, an oil source for leveling operation, vehicle body inclination angle regulating units 17, and a control unit 3. Preferably, the automatically-leveling hydropneumatic suspension mechanism further comprises a suspension mechanism pressure sensor 18 and a vehicle body longitudinal inclination angle sensor 6.

In view of that the connection relations in the automatically-leveling hydropneumatic suspension mechanism in the present invention is complex, the main components of the automatically-leveling hydropneumatic suspension mechanism in the present invention will be detailed first, with reference to the accompanying drawings. On that basis, the electric control connection relation, hydraulic pipeline connection relation and the process of automatically-leveling operation will be detailed then. It is important to note that, since some components of the automatically-leveling hydropneumatic suspension mechanism (e.g., suspension oil cylinders 12 and hydraulic accumulator 11, etc.) are well-known in the art, when describing the components, the well-known components will be described briefly, while the key components of the automatically-leveling suspension mechanism according to the present invention will be explained in detail, such as the vehicle body inclination angle regulating units 17 etc.

Please see FIG. 3 and FIG. 6, The control unit 3 in the present invention is mainly designed to receive sensor signals (e.g., inclination angle signal from the transverse inclination angle sensor 1, and axle load pressure signal from the suspension mechanism pressure sensor 18), select an appropriate inclination angle control mode (e.g., vehicle body transverse inclination angle control mode) according to the inclination angle signal and/or axle load pressure signal, utilize the control software module corresponding to the inclination angle control mode to calculate and analyze the required regulating operation of the corresponding suspension oil cylinders 12, and transmit appropriate electric control signals to the corresponding vehicle body inclination angle regulating units 17, so that the vehicle body inclination angle regulating units 17 control the corresponding suspension oil cylinders 12 to extend or retract and thereby accomplishing the ascending or descending of the vehicle body, so as to regulate the vehicle body to level or essentially level state and ensure safe running of the mobile crane. Wherein, the control unit 3 can be of various types, for example, it may be a single chip microcomputer (SCM) or electronic control unit (ECU), etc. Preferably, the control unit 3 in the automatically-leveling system in the present invention can be a programmable logic controller (PLC), which has the following advantages: owing to the fact that the instruction set and interfaces of PLC are more standard-based, PLC are widely applied in the industrial automatic control domain. Also, owing to the fact that the user program blocks (i.e., the software modules described above) for different vehicle body inclination angle control modes can be edited or modified easily with a programmer unit of PLC, the user program modules for different vehicle body inclination angle control modes can be managed and edited conveniently, so that the automatically-leveling function of the present invention can be implemented more conveniently.

Please see FIG. 3 and FIG. 6, The vehicle body transverse inclination angle sensor 1 may be mounted at the center-of-gravity position on the vehicle body or in the centre-of-gravity area of the vehicle body of mobile crane. Generally speaking, an inclination angle sensor is a sensor used to measure the amount of variation of inclination angle of an object in relation to the horizontal plane. Inclination angle sensors can be classified by working principle into solid pendulum-type inclination angle sensors, liquid pendulum-type inclination angle sensors and gas pendulum-type inclination angle sensors. The automatically-leveling system in the present invention can utilize any type of inclination angle sensors described above. Since gas pendulum-type inclination angle sensors have higher vibration and shock resistant performance, preferably the vehicle body transverse inclination angle sensor I may be a gas pendulum-type inclination angle sensor. When a mobile crane runs on a transverse slope road, the vehicle body transverse inclination angle sensor 1 dynamically monitors the transverse inclination angle of the vehicle body, and transmits the signal of monitored transverse inclination angle of vehicle body to the control unit 3 (e.g., a PLC) through a field bus, such as a CAN Bus (Controller Area Network Bus, an ISO international standard serial communication protocol bus). The control unit 3 judges whether transverse inclination leveling operation is required for the vehicle body on the basis of the received signal of transverse inclination angle of vehicle body; once the transverse inclination angle of vehicle body is greater than the preset value, the control unit 3 will select the vehicle body transverse inclination angle control mode, and send a control signal to the corresponding vehicle body inclination angle regulating units 17, so that the vehicle body inclination angle regulating units 17 will manipulate the corresponding suspension oil cylinders 12 and accomplish vehicle body leveling operation. In a preferred embodiment of automatically-leveling hydropneumatic suspension mechanism in the present invention, the automatically-leveling hydropneumatic suspension mechanism is also required to accomplish automatically-leveling operation against longitudinal slopes; therefore, preferably the automatically-leveling hydropneumatic suspension mechanism further comprises a vehicle body longitudinal inclination angle sensor 6, which can be of the same type as the vehicle body transverse inclination angle sensor 1, such as a gas pendulum-type inclination angle sensor. The vehicle body longitudinal inclination angle sensor 6 can also be mounted at the center-of-gravity position or in the centre-of-gravity area of the vehicle body of mobile crane, and is mainly used to detect the longitudinal inclination angle of the vehicle body of mobile crane, and transmit the longitudinal inclination angle signal to the control unit 3 through a field bus (e.g., a CAN bus), so that the control unit 3 can perform analysis and calculation, and accomplish automatically leveling operation against the longitudinal slope appropriately.

Usually, the suspension mechanism pressure sensor 18 may be an oil pressure sensor, which can be mounted at a special detection port of the suspension valve 13 or suspension oil cylinder 12, and converts the oil pressure signal (the oil pressure signal is correlated with the signal of axle load pressure on the suspension mechanism) by A/D conversion into a digital signal, and transmits the digital signal to the control unit 3 through a field bus (e.g., a CAN bus), so that the control unit 3 can perform analysis and calculation. Alternatively, the suspension mechanism pressure sensor 18 can be a piezoelectric sensor or pressure sensor, instead of the oil pressure sensor described above; in that case, the pressure-sensing element (e.g., a strain gage) of the piezoelectric sensor or pressure sensor can be arranged on the connection position between the suspension oil cylinder 12 and the vehicle frame 15.

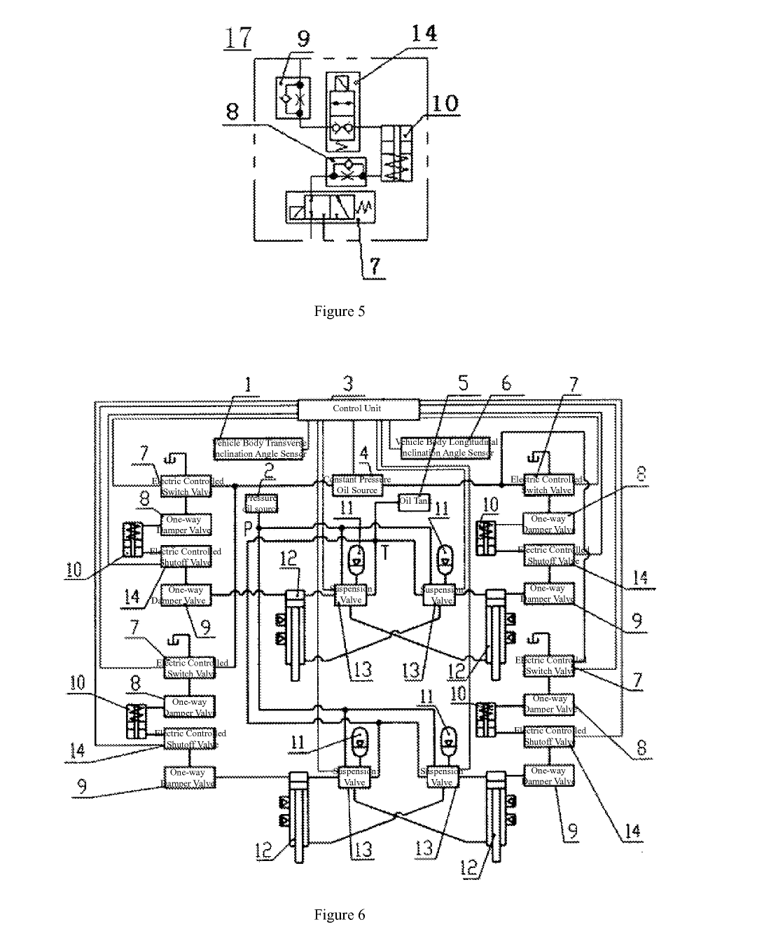

Please see FIG. 4, The vehicle body inclination angle regulating unit 17 of automatically-leveling hydropneumatic suspension mechanism in the present invention comprises an electric controlled switch valve 7, a first one-way damper valve 8, an electric controlled shutoff valve 14, a second one-way damper valve 9, and a balancing oil cylinder 10. Please see FIG. 5, In the vehicle body inclination angle regulating unit 17, the electric controlled switch valve 7 can be a two-position three-way solenoid valve, which is mainly used to accomplish switching between pressure oil supply and oil return; the first one-way damper valve 8 and the second one-way damper valve 9 are elements that are well-known in the art, specifically, the first one-way damper valve 8 and the second one-way damper valve 9 respectively comprise a one-way valve and a damping valve connected in parallel, and are mainly designed to accomplish a function of “quick oil supply and slow oil return”; the balancing oil cylinder 10 is preferably a spring-return oil cylinder, which is to say, a return spring is arranged in one of the two chambers on both sides of the piston in the oil cylinder; the balancing oil cylinder 10 is mainly used to accomplish an oil reservoir function; of course, besides a spring-return oil cylinder, the balancing oil cylinder 10 can be in any other form within the technical concept of the present invention, as long as it can accomplish the oil reservoir function. For example, it can be a hydraulic accumulator, etc.; in the simplest form, the spring in the spring-return oil cylinder described above can be replaced with an elastic element (e.g., a rubber elastomer); these simple variants are easy to conceive for those skilled in the art (in the following text, the balancing oil cylinder 10 will be described in the example of a spring-return oil cylinder); the electric controlled shutoff valve 14 can be a two-position two-way solenoid valve, which is mainly designed to accomplish pressure oil way open and locking. It is noted that the electric controlled shutoff valve 14 and electric controlled switch valve 7 described above are only exemplary for interpreting the present invention. Actually, a wide variety of electric controlled valves can be used to implement oil way switching or shutoff. In other words, the electric controlled shutoff valve 14 and electric controlled switch valve 7 can be any type of valves, not limited to the two-position two-way solenoid valve and two-position three-way solenoid valve shown in FIG. 5, as long as they can implement the oil way switching and connection relation shown in FIG. 5. In FIG. 5, the electric controlled switch valve 7 is connected to the first one-way damper valve 8, which in turn is connected to the port of spring chamber of the balancing oil cylinder 10; the port of non-spring chamber of the balancing oil cylinder 10 is connected to the electric controlled shutoff valve 14, and the electric controlled shutoff valve 14 is connected to the second one-way damper valve 9.

Please see FIG. 6, The pressure oil source 2 can be a hydraulic pump, which pumps oil from the oil tank 5 and pressurizes the oil, so as to supply pressure oil to the automatically-leveling hydropneumatic suspension mechanism in the present invention. Moreover, the automatically-leveling hydropneumatic suspension mechanism in the present invention further comprises an oil source for leveling operation. The oil source for leveling operation is preferably a constant pressure oil source 4, which is mainly designed to supply hydraulic oil at a relatively constant pressure. Usually, hydraulic oil supply at a relatively constant pressure can be implemented by arranging an overflow valve in the outlet pipe of the hydraulic pump. In FIG. 6, the constant pressure oil source 4 is connected to the electric controlled switch valve 7 in the vehicle body inclination angle regulating unit 17 through a hydraulic pipeline; in addition, the constant pressure oil source 4 is also electrically connected to the control unit 3 through a control line, therefore, the working state of the hydraulic pump for the constant pressure oil source 4 can be controlled by the control unit 3, so that oil is supplied to the electric controlled switch valve selectively by means of the control of the control unit 3. Of course, it is noted here that the constant pressure oil source 4 is mainly used to drive the balancing oil cylinders 10 of the vehicle body inclination angle regulating units 17. The constant pressure oil source 4 can ensure stability of leveling operation and avoid fluctuations of operating pressure during the leveling operation; however, the constant pressure oil source 4 is only a preferred option, which is to say, any other common pressure oil source can be used as the oil source for leveling operation; in that case, the object of the present invention can also be attained, though the leveling operation with such a pressure oil source may not be as stable as the leveling operation with the constant pressure oil source 4. The oil tank 5 is an common hydraulic element in the hydraulic system, and is mainly used to store the oil in the hydraulic system.

The suspension oil cylinders 12 are common components in hydropneumatic suspension mechanisms (e.g., the suspension oil cylinders described in CN2601870Y and CN2454171Y), and are known in structure, usually comprise a cylinder barrel, a piston, and a cylinder rod, etc., respectively; wherein, the bottom of cylinder barrel and the top of cylinder rod have a hinged hole for hinging to the vehicle bridge 16 and vehicle frame 15 respectively. The suspension oil cylinders 12 in the hydropneumatic suspension mechanism are mainly used to bear the axle load of the mobile engineering machine (e.g., a mobile crane). By controlling the hydraulic oil to flow into the rod chamber or non-rod chamber of a suspension oil cylinder 12, the cylinder rod in the suspension oil cylinder 12 can be controlled to extend or retract, so as to lift up or lower down the vehicle frame 15.

Please see FIG. 6, the automatically-leveling hydropneumatic suspension mechanism in the present invention further comprises suspension valves 13 and hydraulic accumulators 11. the suspension valves 13 are also referred to as a “suspension valve assembly” or “vehicle suspension valves”, wherein, “suspension” is a synonym of “vehicle suspension system”. The suspension valves 13 are common components of hydropneumatic suspension mechanisms (e.g., the suspension valves described in CN2601870Y). The suspension valves 13 are mainly used to control the rigid/elastic state switching and extension/retraction of suspension oil cylinders 12. The suspension valve 13 is a combined valve, and its elements are known in the art, preferably, the suspension valve 13 comprises a suspension oil cylinder's rigid and elastic state control valve 19, a suspension oil cylinder extension control valve 20, and a suspension oil cylinder retraction control valve 21. The hydraulic accumulator 11 is a well-known component in hydraulic systems. It contains hydraulic oil, with inert gas (e.g., nitrogen) having a initial pressure sealed above the hydraulic oil. It is noted that the connection relation among the suspension oil cylinders, 12, suspension valves 13, and hydraulic accumulators 11 is not directly related with the automatically-leveling capability of the automatically-leveling hydropneumatic suspension mechanism in the present invention. However, in view that they are common components in existing hydropneumatic suspension mechanisms and may have influence on the understanding of the present invention, hereunder the connection relation among the suspension oil cylinders 12, suspension valves 13, and hydraulic accumulators 11 and associated functional states will be described briefly.

As described above, the suspension oil cylinders 12 are mounted on both sides of a vehicle bridge 16 in symmetry. Corresponding to the arrangement of the suspension oil cylinders 12, the suspension valves 13 are usually used in pairs. A wide variety of suspension valves exist in the prior art. However, these suspension valves are composed of similar constituent elements (the difference mainly lies in that some damping valves or one-way valves are added or reduced), and accomplish similar functions, i.e., they are mainly used to control rigid/elastic state switching and extension/retraction of the suspension oil cylinders 12 (i.e., oil supply to and oil return from the suspension oil cylinders 12). Of course, in the early stage of hydropneumatic suspension technique, there were some suspension valves with simple structures (e.g., directional control valves matched with the suspension oil cylinders 12, etc.; in the present invention, these valves are generally referred to as “suspension valves”). The automatically-leveling hydropneumatic suspension mechanism in the present invention can utilize different types of suspension valves 13, which is to say, the specific type of suspension valves 13 doesn't constitute any limitation to the protected domain of the present invention.

For example, FIG. 7 is a schematic diagram that shows the connection relation between a typical suspension valve 13 and suspension oil cylinder 12, wherein, P represents an oil supply port, while T represents an oil return port. Suppose the suspension oil cylinders 12 shown in the figure are respectively mounted on the both sides of a rear axle 16 (hereinafter the left side and right side will be differentiated in the description, for example, left suspension oil cylinder 12, and right suspension oil cylinder 12, etc., accordingly, suppose the lower side is left side and the upper side is right side in FIG. 7). As shown in FIG. 7, the left suspension valves 13 and right suspension valves 13 are mounted on the both sides of the rear axle 16 respectively, with the upper end of cylinder rod hinged to the vehicle frame 15 and the lower end of cylinder barrel hinged to the rear vehicle bridge 16. Though the left and right suspension valves 13 respectively correspond to the left and right suspension oil cylinders 12, the left and right suspension valves 13 and the left and right suspension oil cylinders 12 are not independent from each other; instead, they are in an related connection relation with each other, so as to form a coordinated relation, and thereby facilitating the implementation of such functions as vibration damping of the hydropneumatic suspension mechanism and static regulation of the height of vehicle frame relative to ground, etc. Specifically, the left and right suspension valves 13 may comprise a suspension oil cylinder's rigid and elastic state control valve 19 respectively, wherein, the oil port of the left hydraulic accumulator 11 is connected to the non-rod chamber of the left suspension oil cylinder 12 by a hydraulic pipeline provided with the left suspension oil cylinder's rigid and elastic state control valve 19, the oil port of the right hydraulic accumulator 11 is connected to the non-rod chamber of the right suspension oil cylinder 12 by a hydraulic pipeline provided with the right suspension oil cylinder's rigid and elastic state control valve 19; the left and right suspension oil cylinder's rigid and elastic state control valves 19 have two working states, i.e., closed and open states; accordingly, the left and right suspension oil cylinder's rigid and elastic state control valves 19 may be normally-closed type two-position two-way solenoid directional valves or solenoid switch valves, etc. (in FIG. 6, the suspension valves 13 are electrically connected to the control unit 3 through a control line; therefore, the open/close state of the left and right suspension oil cylinder's rigid and elastic state control valves 19 can be controlled by the control unit 3). Thus, for example, when the mobile crane runs under normal road conditions, the left and right suspension oil cylinder's rigid and elastic state control valves 19 are energized under control of the control unit 3, so that the left and right suspension oil cylinders 12 communicate with the left and right hydraulic accumulators 11 respectively, and thereby the left and right hydraulic accumulators 11 can be utilized to absorb vibrations, so as to improve vehicle running smoothness and driving comfort. When the mobile crane is in lifting work state under load, the left and right suspension oil cylinder's rigid and elastic state control valves 19 are de-energized under control of the control unit 3, so that the left and right suspension oil cylinders 12 are separated from the left and right hydraulic accumulators 11 respectively, and therefore the oil in the non-rod chambers of left and right suspension oil cylinders 12 is retained in the essentially sealed non-rod chambers. Due to the incompressibility or quasi-incompressibility of hydraulic oil, the hydropneumatic suspension mechanism is in rigid state, and the suspension oil cylinders 12 will not retract under pressure, no matter how high the pressure exerted by the vehicle frame 15 on the cylinder rods of the suspension oil cylinders 12 is; thus, the safety of lifting and running under load can be ensured (of course, once the mobile crane runs onto a transverse slope road or longitudinal slope road, the vehicle body or vehicle frame 15 will incline due to the slope, and therefore the mobile crane will be endangered with an overturning risk if the vehicle body or vehicle frame 15 is not leveled dynamically). In addition, as shown in FIG. 7, the rod chamber of the left suspension oil cylinder 12 also communicates with the oil port of the right hydraulic accumulator 11 through a pipeline (usually, the rod chamber of the left suspension oil cylinder 12 may be connected to a corresponding port of the right suspension valve 13 through the pipeline, and then communicate with the oil port of the right hydraulic accumulator 11 through an internal channel of the right suspension valve 13); the rod chamber of the right suspension oil cylinder 12 communicates with the oil port of the left hydraulic accumulator 11 through a pipeline. Thus, when the mobile crane runs under normal road conditions (in that running state, the left and right suspension oil cylinder's rigid and elastic state control valves 19 are in energized state) and enters into a left curve (the road surface of a left curve usually has a left directional slope), the load on the left side of the vehicle bridge 16 will significantly increase, and the cylinder rod in the left suspension oil cylinder 12 will move downwards; accordingly, the oil pressure between the left suspension oil cylinder 12 and the left hydraulic accumulator 11 will increase quickly, the increased oil pressure will act on the rod chamber of the right suspension oil cylinder 12 through the connecting pipeline, and therefore press down the piston in the right suspension oil cylinder 12 and prevent the cylinder rod in the right suspension oil cylinder 12 from extending. In that way, the side inclination angle of the mobile crane can be reduced effectively. Of course, the case is similar when the mobile crane runs into a right curve.

In addition, as described above, preferably the suspension valves 13 further comprise a suspension oil cylinder extension control valve 20 and a suspension oil cylinder retraction control valve 21 respectively, wherein, the oil supply port P is connected to the non-rod chamber of the left suspension oil cylinder 12 via the left suspension oil cylinder extension control valve 20, and is also connected to the non-rod chamber of the right suspension oil cylinder 12 via the right suspension oil cylinder extension control valve 20; whereas, the left suspension oil cylinder retraction control valve 21 is arranged in the pipeline between the oil return port T and the non-rod chamber of the left suspension oil cylinder 12, and the right suspension oil cylinder retraction control valve 21 is arranged in the pipeline between the oil return port T and the non-rod chamber of the right suspension oil cylinder 12. The left and right suspension oil cylinder extension control valves 20 and left and right suspension oil cylinder retraction control valves 21 are respectively two-position two-way solenoid directional valves or electrically-controlled switch valves (in FIG. 6, each of the suspension valves 13 is electrically connected to the control unit 3 through control line; therefore, the open and close state of the left and right suspension oil cylinder extension control valves 20 and suspension oil cylinder retraction control valves 21 can be controlled by the control unit 3). Thus, when the left and right suspension oil cylinder extension control valves 20 are controlled in energized state, the pressure oil will flow through the oil supply port P into the non-rod chambers of the left and right suspension oil cylinders 12 via the left and right suspension oil cylinder extension control valves 20 respectively, so the cylinder rods in the left and right suspension oil cylinders 12 will extend, and thereby the vehicle frame 15 or vehicle body will be elevated up. When the left and right suspension oil cylinder retraction control valves 21 are controlled in energized state, the hydraulic oil in the non-rod chambers of the left and right suspension oil cylinders 12 will be forced to flow out under the pressure of the vehicle frame 15 and vehicle body; therefore, the cylinder rods in the left and right suspension oil cylinders 12 will retract, and the vehicle frame and vehicle body of the mobile crane will be lowered down. Of course, the extension or retraction may not be synchronous among the suspension oil cylinders 12. Even the suspension oil cylinders on the both sides of the same vehicle bridge 16 can be controlled separately. However, the regulation is usually performed when the mobile crane is in static state. The regulation of the height of vehicle frame 15 or vehicle body of a mobile crane above the ground by means of the suspension valves 13 is a sort of rough regulation, and the state of the non-rod chambers of suspension oil cylinders 12 is equivalent to unloading state when the suspension oil cylinder retraction control valves 21 in the suspension valves 13 are in energized state and open, which is very dangerous when the mobile crane runs (especially on a transverse slope road); in addition, when oil is supplied with the suspension oil cylinder extension control valves 20 in the suspension valves 13 in energized state, it is impossible to control the oil feeding amount into the non-rod chambers of the suspension oil cylinders 12; therefore, the regulation of the height of vehicle frame or vehicle body above the ground by means of the suspension valves 13 is not suitable for dynamically and automatically leveling operation for vehicle body or vehicle frame. Moreover, such regulation is usually different depending on the different task conditions, for example, in the case that the elevation of vehicle body of a mobile crane is to be decreased before the mobile crane passes through a culvert.

The above text describes the main components of the automatically-leveling hydropneumatic suspension mechanism according to the present invention. The connection relation among the suspension oil cylinders 12, suspension valves 13, and hydraulic accumulators 11 is described briefly when the suspension valves 13 and hydraulic accumulators 11 are described. It is important to note: since the suspension oil cylinders 12, suspension valves 13, and hydraulic accumulators 11 are common components of hydropneumatic suspension mechanisms and the connection relation among the suspension oil cylinders 12, suspension valves 13, and hydraulic accumulators 11 is well-known by those skilled in the art, so, once describing that the suspension oil cylinders 12 are connected with suspension valves 13 and hydraulic accumulators 11, the connection relation among those components can be understood clearly by those skilled in the art (suspension valves 13 available in the market usually have standard connecting ports). Therefore, in the following text where the connection relation in the automatically-leveling hydropneumatic suspension mechanism according to the present invention is described, the connection relation among the suspension oil cylinders 12, suspension valves 13, and hydraulic accumulators 11 will be described briefly only, while the focus will be set to the description of hydraulic pipeline connection relation and electric control connection relation among key components that are directly related with the automatically-leveling capability in the present invention. In addition, the main technical concept of the automatically-leveling hydropneumatic suspension mechanism according to the present invention lies in the electric control connection relation and hydraulic pipeline connection relation, instead of the mechanical installation relation, such as the mechanical installation structures of the suspension valves 13 and vehicle body inclination angle regulating units 17, etc. These components can be mounted to the vehicle frame 15 or vehicle body by means of appropriate mounting brackets and fasteners as required during the actual installation process.

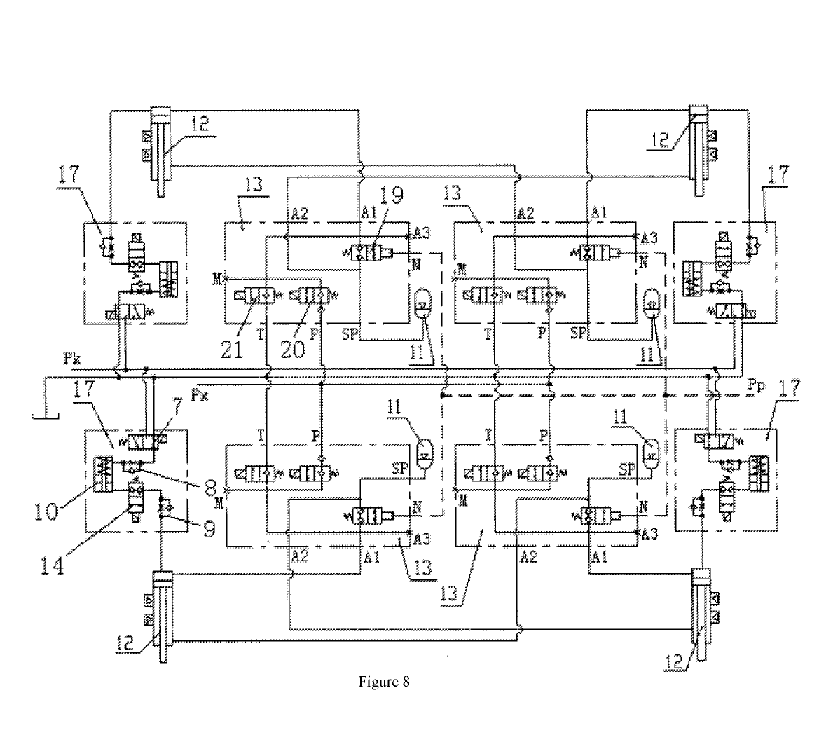

Hereunder the hydraulic pipeline connection relation and electric control connection relation in the automatically-leveling hydropneumatic suspension mechanism according to a preferred embodiment of the present invention will be described, with reference to FIG. 6 and FIG. 8. Both FIG. 6 and FIG. 8 show the case of a twin-axle mobile crane. However, apparently, the technical scheme of automatically-leveling hydropneumatic suspension mechanism according to the present invention is also applicable to multi-axle mobile cranes or other mobile engineering machines. Wherein, FIG. 6 is a structural block diagram showing the overall arrangement form of the automatically-leveling hydropneumatic suspension mechanism according to the present invention; FIG. 8 is a hydraulic system principle diagram of the automatically-leveling hydropneumatic suspension mechanism shown in FIG. 6.

Please see FIG. 6, The automatically-leveling hydropneumatic suspension mechanism according to the present invention comprises at least two pairs of suspension oil cylinders 12, each pair of which is mounted on the both sides of a corresponding vehicle bridge 16 in symmetry (for example, in FIG. 6, the suspension oil cylinders 12 are mounted in pairs on the both sides of the front axle and rear axle respectively). Each pair of suspension oil cylinders 12 are connected with associated suspension valves 13 and hydraulic accumulators 11. Since the connection relation among the suspension oil cylinders 12, suspension valves 13, and hydraulic accumulators 11 have been described above and are well-known by those skilled in the art, it will not be further described here any more. In FIG. 6, the oil source 2 (pressure oil source) at the oil supply port P is mainly used to supply pressure oil to the suspension oil cylinders 12, and the oil tank 5 at the oil return port T is mainly used to store the return oil. Furthermore, to control the suspension valves 13, each suspension valve 13 is electrically connected to the control unit 3 by an electric control line; thus, the normal rigid and elastic state switching of hydropneumatic suspension mechanism and the oil supply and return of suspension oil cylinders 12 can be implemented by controlling the suspension valves 13.

Each suspension oil cylinder 12 is equipped with a vehicle body inclination angle regulating unit 17. As described above, the vehicle body inclination angle regulating unit 17 comprises an electric controlled switch valve 7, a first one-way damper valve 8, an electric controlled shutoff valve 14, a second one-way damper valve 9, and a balancing oil cylinder 10. In this embodiment, the balancing oil cylinder 10 is a spring-return oil cylinder, the spring chamber of balancing oil cylinder 10 is connected to the oil tank 5 and constant pressure oil source 4 by a hydraulic pipeline provided with the first one-way damper valve 8 and electric controlled switch valve 7. The electric controlled switch valve 7 controls the spring chamber of the balancing oil cylinder 10 to communicate with the oil tank 5 or constant pressure oil source 4 selectively. Seeing FIG. 5 and FIG. 8, Preferably, the electric controlled switch valve 7 is a two-position three-way solenoid directional valve, the spring chamber of the balancing oil cylinder 10 is connected to a port of the two-position three-way solenoid directional valve by a hydraulic pipeline provided with the first one-way damper valve 8 (wherein the reversely cutoff side of one-way valve in the first one-way damper valve 8 is connected to the spring chamber of balancing oil cylinder 10 by a hydraulic pipeline), and the other two ports of the two-position three way solenoid directional valve are respectively connected to the oil tank 5 and constant pressure oil source 4. When the two-position three-way solenoid directional valve is de-energized, the spring chamber of the balancing oil cylinder 10 will communicate with the oil tank 5 via the first one-way damper valve 8 and the electric controlled switch valve 7; when the two-position three-way solenoid directional valve is energized, the valve core in the two-position three-way solenoid directional valve will shift, and thereby the spring chamber of balancing oil cylinder 10 will communicate with the constant pressure oil source 4 via the first one-way damper valve 8 and the electric controlled switch valve 7; thus, the constant pressure oil source 4 is controlled by the control unit 3 to operate and supply oil into the spring chamber of the balancing oil cylinder 10. In addition, it is important to noted that the electric controlled switch valve 7 can be of other type, for example, it can be a two-position four-way solenoid directional valve, and, in that case, a branch pipe may be routed from the connecting pipe between the first one-way damper valve 8 and the electric controlled switch valve 7 shown in FIG. 5 and be connected to a port of the two-position four-way solenoid directional valve. Of course, those skilled in the art can conceive that the electric controlled switch valve 7 can be implemented with other type of electric controlled valves, as long as it can switch the oil way of the spring chamber of balancing oil cylinder 10 between the oil tank 5 and the constant pressure oil source 4. Seeing FIGS. 5 and 6, the non-spring chamber of balancing oil cylinder 10 (i.e., the chamber that opposites to the spring chamber and doesn't have spring) is connected to the non-rod chamber of suspension oil cylinder 12 by a hydraulic pipeline provided with the electric controlled shutoff valve 14 and second one-way damper valve 9. The reversely cutoff side of the one-way valve in the second one-way damper valve 9 is connected to the non-rod chamber of suspension oil cylinder 12 by a hydraulic pipeline. Preferably, as shown in FIG. 5, the electric controlled shutoff valve 14 is a two-position two-way solenoid valve, and is mainly designed to implement a switching function. Those skilled in the art can conceive a wide variety of electric controlled valves that implement the switching function, such as electric controlled switch valves, etc. In addition, as described above, the one-way damper valves 8 and 9 are composed of components that are well-known in the art. Specifically, the one-way damper valves 8 and 9 respectively comprise a one-way valve and a damper valve connected in parallel. In the internal connection relation in the vehicle body inclination angle regulating unit 17, the positively communication side of the one-way valve in the first one-way damper valve 8 is connected to a port of the electric controlled switch valve 7, and the positively communication side of the one-way valve in the second one-way damper valve 9 is connected to the electric controlled shutoff valve 14.

In addition, the electric controlled switch valve 7 and the electric controlled shutoff valve 14 of each vehicle body inclination angle regulating unit 17 is electrically connected to the control unit 3 through electric control wires, and the constant pressure oil source 4 is electrically connected to the control unit 3 through electric control wires (thus, the constant pressure oil source 4 is controlled by the control unit 3, so that the constant pressure oil source 4 selectively supplies oil to the electric controlled switch valve 7). Moreover, as described above, since the basic function to be implemented with the automatically-leveling hydropneumatic suspension mechanism according to the present invention is an automatically and dynamically leveling function against transverse slopes, a vehicle body inclination angle sensor 1 has to be mounted. The vehicle body inclination angle sensor 1 is connected to the control unit 3 through a fieldbus (e.g., CAN signal wires) to transmit the signal of transverse inclination angle of vehicle body of the mobile crane to the control unit 3. Though not shown in FIG. 6, preferably the automatically-leveling hydropneumatic suspension mechanism according to the present invention further comprises a suspension mechanism pressure sensor 18, which is also connected to the control unit 3 through signal line to transmit a signal of axle load pressure of the mobile crane to the control unit 3. Preferably, the vehicle body longitudinal inclination angle sensor 6 of the automatically-leveling hydropneumatic suspension mechanism according to the present invention transmits a signal of longitudinal inclination angle of vehicle body to the control unit 3 through signal line (e.g., a CAN bus).

FIG. 8 is a hydraulic system principle diagram of the automatically-leveling hydropneumatic suspension mechanism shown in FIG. 6, wherein, the connection relation of the suspension valve 13 and the hydraulic accumulator connected between each pair of suspension oil cylinders 12 has been described with reference to FIG. 7. In addition, It is clearly seen from FIG. 8: Each suspension oil cylinder 12 is connected with a vehicle body inclination angle regulating unit 17, wherein, the hydraulic pipeline connection relation and electric control connection relation have been detailed in the above text. Moreover, in FIG. 8, Pk represents the oil output pipeline from the constant pressure oil source 4, Px represents the oil output pipeline from the pressure oil source 2, and Pp represents the electric control circuit or line. The symbols A1, A2, A3, M, N, P, T, and SP, etc. indicated at each suspension valve 13 represent ports. Usually, suspension valves 13 available in the market can be connected at appropriate ports/interfaces to form the connection relation shown in FIG. 8.

In the above text, the main components of the automatically-leveling hydropneumatic suspension mechanism according to the present invention and the associated hydraulic pipeline connection relation and electric control connection relation are described with reference to the accompanying drawings. Hereunder the basic technical scheme of vehicle body inclination angle regulating unit 17, automatically-leveling hydropneumatic suspension mechanism, and mobile crane according to the present invention will be summarized briefly, and, on that basis, the operation process of automatically-leveling operation of the automatically-leveling hydropneumatic suspension mechanism in the present invention will be detailed.

It is seen from above description: the technical solution of the vehicle body inclination angle regulating unit 17 provided by the present invention is: the vehicle body inclination angle regulating unit 17 comprises an electric controlled switch valve 7, a first one-way damper valve 8, an electric controlled shutoff valve 14, a second one-way damper valve 9, and a balancing oil cylinder 10, wherein, the balancing oil cylinder 10 is a spring-return type oil cylinder, with the spring chamber of the balancing oil cylinder 10 connected to the electric controlled switch valve 7 by a hydraulic pipeline provided with the first one-way damper valve 8, the electric controlled switch valve 7 selectively switch the flow direction of the oil way of the spring chamber of the balancing oil cylinder 10; the non-spring chamber of balancing oil cylinder 10 is connected to the second one-way damper valve 9 by a hydraulic pipeline provided with the electric controlled shutoff valve 14, and the electric controlled shutoff valve 14 selectively communicate or shut the oil way of the non-spring chamber of balancing oil cylinder 10.

The basic technical solution of the automatically-leveling hydropneumatic suspension mechanism according to the present invention is: the automatically-leveling hydropneumatic suspension mechanism comprises at least two pairs of suspension oil cylinders 12, each pair of which is mounted on the both sides of a corresponding vehicle bridge 16, wherein, the automatically-leveling hydropneumatic suspension mechanism further comprises: vehicle body inclination angle regulating units 17, each of which corresponds to one suspension oil cylinder 12 of the suspension oil cylinders and comprises an electric controlled switch valve 7, a first one-way damper valve 8, an electric controlled shutoff valve 14, a second one-way damper valve 9, and a balancing oil cylinder 10, wherein, the balancing oil cylinder 10 is a spring-return type oil cylinder, with the spring chamber of the balancing oil cylinder 10 connected to an oil tank 5 and an oil source for leveling operation (preferably a constant pressure oil source 4) via the first one-way damper valve 8 and electric controlled switch valve 4, and the electric controlled switch valve 7 selectively controls the spring chamber of balancing oil cylinder 10 to communicate with the oil tank 5 or constant pressure oil source 4, the non-spring chamber of balancing oil cylinder 10 is connected to the non-rod chamber of the corresponding suspension oil cylinder 12 by a hydraulic pipeline provided with the electric controlled shutoff valve 14 and the second one-way damper valve 9, and the electric controlled shutoff valve 14 selectively communicates or shuts the oil way between the non-spring chamber of balancing oil cylinder 10 and the non-rod chamber of suspension oil cylinder 12; a vehicle body transverse inclination angle sensor, designed to detect the transverse inclination angle of vehicle body; and a control unit 3, which receives the signal of transverse inclination angle of vehicle body sent by the vehicle body transverse inclination angle sensor 1, and is connected to the oil source for leveling operation and the electric controlled switch valve 7 and the electric controlled shutoff valve 14 in each vehicle body inclination angle regulating unit 17 through electric control lines.

Preferably, the automatically-leveling hydropneumatic suspension mechanism further comprises a vehicle body longitudinal inclination angle sensor 6, which is connected to the control unit 3 through a fieldbus (e.g., a CAN bus), and transmits a signal of longitudinal inclination angle of vehicle body to the control unit 3.

It is important to note that the automatically-leveling suspension structure according to the present invention is applicable to a wide variety of mobile engineering machines, such as wheeled loaders, Mine dump trucks, wheeled diggers, and mobile cranes (typically all-terrain cranes), etc. Furthermore, the present invention provides a mobile crane, which comprises the automatically-leveling hydropneumatic suspension mechanism described above.

Hereunder the automatically and dynamically leveling operation of the automatically-leveling hydropneumatic suspension mechanism according to the present invention against transverse slopes will be described, with reference to FIG. 6 and FIG. 8, in an example of a twin-axle (i.e., front vehicle bridge and rear vehicle bridge) mobile crane. For convenience of description, suppose the upper side in FIG. 6 is the head side of the mobile crane, and the lower side is the tail side of the mobile crane; accordingly, the left side in FIG. 6 is the left side of the mobile crane, and the right side in FIG. 6 is the right side of the mobile crane; wherein, the two suspension oil cylinders 12 in the front position are suspension oil cylinders on the both sides of the front vehicle bridge (referred to as front left suspension oil cylinder and front right suspension oil cylinder respectively), the two suspension oil cylinders 12 in the rear position are suspension oil cylinders 12 on the both sides of the rear vehicle bridge (referred to a rear left suspension oil cylinder and rear right suspension oil cylinder respectively). It should be noted that the FIG. 6 is only a structural block diagram showing an overall arrangement of the automatically-leveling hydropneumatic suspension mechanism according to the present invention. Though the cylinder rods in the suspension oil cylinders 12 shown in FIG. 6 (and FIG. 8) are drawn in a downward arrangement, the cylinder rods in the suspension oil cylinders should be in an upward arrangement and hinged to the vehicle frame 15 or vehicle body in the actual installation process.

Usually, when the mobile crane runs on a transverse slope road, the vehicle frame 15 or vehicle body will take on a side inclination state, no matter whether the mobile crane bears load or not. Specifically, as described above, when the mobile crane runs in the normal running state (without heavy load), the suspension oil cylinder's rigid and elastic state control valves 19 in suspension valves 13 of the hydropneumatic suspension mechanism are in energized state, thus the suspension oil cylinders 12 are in elastic state; when the mobile crane runs on a transverse slope road, since the suspension oil cylinders 12 on the both sides of the hydropneumatic suspension mechanism are in elastic state, under the action of self-weight of the mobile crane, the vehicle frame 15 or vehicle body of the mobile crane will have a side inclination angle more than the transverse slope; when the mobile crane runs with load, the suspension oil cylinder's rigid and elastic state control valves 19 in suspension valves 13 in the hydropneumatic suspension mechanism are in de-energized state, and therefore the suspension oil cylinders 12 are in rigid state; when the mobile crane runs on a transverse slope road, though the suspension oil cylinders 12 on the both sides of the hydropneumatic suspension mechanism can't extend or retract because they are in rigid state, the overall side inclination angle of the mobile crane (of course, including the vehicle frame 15 and vehicle body) will be equal to the transverse slope, due to the existence of transverse slope.

For a mobile crane equipped with the automatically-leveling hydropneumatic suspension mechanism described in the present invention, when the mobile crane runs on a transverse slope road, the vehicle body transverse inclination angle sensor 1 and suspension mechanism pressure sensor 18 transmit the signal of transverse inclination angle of vehicle body and the signals of left and right axle load pressure values to the control unit 3 in real time; when the control unit 3 keeps or alters the vehicle body attitude, preferably a stable constant pressure oil source 4 is utilized to supply power, and the control unit 3 controls the electric controlled shutoff valves 14 and electric controlled switch valves 7 to force the hydraulic oil in the balancing oil cylinders 10 to flow out or cut off the hydraulic oil flow, and thereby keeps constant oil amount in the hydropneumatic suspension mechanism and balanced axle load, achieving dynamic suspension leveling against the transverse slope.

For example, when the mobile crane runs onto a transverse slope road that slopes to the right, the vehicle body will incline to the right instantly; immediately, the vehicle body transverse inclination angle sensor 1 transmits a signal of transverse inclination angle to the control unit 3; preferably the suspension mechanism pressure sensor 18 transmits left and right axle load pressure signals to the control unit 3; the control unit 3 judges whether the transverse inclination angle of vehicle body at the moment has reached to a preset value or not; if the transverse inclination angle of vehicle body has reached to the preset value, the control unit 3 will select the vehicle body transverse inclination angle control mode to control; the control unit 3 performs analysis via a software module corresponding to the vehicle body transverse inclination angle control mode, and then outputs a current or voltage control signal, which controls the constant pressure oil source 4 to stop work, which is to say, the constant pressure oil source 4 doesn't output hydraulic oil any more (i.e., the hydraulic pump for the constant pressure oil source 4 doesn't work at the moment); at the same time, the left electric controlled shutoff valves 14 on the mobile crane are energized, so that the hydraulic oil in the non-rod chamber of each of the left suspension oil cylinders 12 fills the non-spring chamber of the corresponding one of the left balancing oil cylinders 10 gradually via the corresponding second one-way damper valve 9; in addition, each of the left electric controlled switch valves 7 are de-energized, so that the oil in the spring chamber of each of the left balancing oil cylinders 10 returns to the oil tank 5 via the corresponding first one-way damper valve 8; thus, the cylinder rods in the left suspension oil cylinders 12 on the mobile crane retract, so that the vehicle frame and vehicle body inclining to the right are lowered toward left under the action of self-weight. It is noted: here, though the hydraulic oil in the non-rod chamber of each of left suspension oil cylinder 12 on the mobile crane flows into the non-spring chamber of the corresponding balancing oil cylinder 10, the hydraulic oil in the non-rod chambers of the suspension oil cylinders 12 still keeps appropriate pressure since the pistons in the balancing oil cylinders 10 are resisted by the return springs, and therefore the vehicle frame or vehicle body is supported stably (i.e., the left suspension oil cylinders 12 are not unloaded at the moment), this can ensure smoothness of the automatically-leveling operation on the mobile crane, and ensure safety of the mobile crane. In the process of automatically-leveling operation, the vehicle body transverse inclination angle sensor 1 and suspension mechanism pressure sensor 18 keep on monitoring transverse inclination angle of vehicle body and left axle load pressure signal, till the difference between left and right axle load pressure values and the vehicle body inclination angle return to the initial vehicle body level set values; then, the left electric controlled switch valves 7 are energized under control of the control unit 3, so that the hydraulic oil in the spring chamber of each of left balancing oil cylinders 10 is sealed in the chamber (i.e., the oil ways of the spring chambers of balancing oil cylinders 10 are switched to communicate with the constant pressure oil source 4, but the constant pressure oil source 4 doesn't work at this time), and thereby the mobile crane keeps in the attitude after the vehicle body is leveled.

When the mobile crane passes the transverse slope road that slopes to the right and runs onto a level road, the vehicle body transverse inclination angle sensor 1 and suspension mechanism pressure sensor 18 continue transmitting the signal of transverse inclination angle of vehicle body and left and right axle load pressure signals to the control unit 3 in real time. Now, since the mobile crane has run onto a level road, the attitude of vehicle body that was leveled on the transverse slope road will surely exhibit that the vehicle body inclines to the left; at this time, the control unit 3 receives the signals from the vehicle body transverse inclination angle sensor 1 and suspension mechanism pressure sensor 18, and controls the constant pressure oil source 4 to output oil; the left electric controlled shutoff valves 14 are energized, and thereby the non-rod chamber of each of the left suspension oil cylinders 12 communicates with the non-spring chamber of the corresponding left balancing oil cylinder 10 via the corresponding first one-way damper valves 9 respectively; the left electric controlled switch valves 7 are energized, and thereby the hydraulic oil from the constant pressure oil source 4 flows into the spring chambers of corresponding balancing oil cylinders 10 via each of the first one-way damper valves 8 and drives the pistons in the balancing oil cylinders 10, so that the hydraulic oil in the non-spring chamber of each of the balancing oil cylinders 10 is pressed into the non-rod chamber of the corresponding suspension oil cylinders 12 via the corresponding second one-way damper valves 9; thus, the cylinder rods in the left suspension oil cylinders 12 extend, and thereby the left part of vehicle body of the mobile crane is elevated, till the pressure difference between the left part and right part of the suspension mechanism and the vehicle body inclination angle return to their initial vehicle body level values; finally, the left electric controlled shutoff valves 14 are de-energized, and thereby the hydraulic oil in the left suspension oil cylinders 12 is sealed; as a result, the vehicle body is kept in the level altitude.

The above text describes the automatically and dynamically leveling operation of a mobile crane against transverse inclination angle when the mobile crane runs on a transverse slope road that slopes to the right and then runs onto a level road again from the transverse slope road. The automatically and dynamically leveling operation of a mobile crane against transverse inclination angle when the mobile crane runs on a transverse slope road that slopes to the left and then runs onto a level road again from the transverse slope road is similar; in that case, the right suspension oil cylinders 12 on the mobile crane can be regulated with the right vehicle body inclination angle regulating unit 17 to achieve the leveling operation object.

Moreover, preferably, the automatically-leveling hydropneumatic suspension mechanism according to the present invention further comprises a vehicle body longitudinal inclination angle sensor 6, the control unit 3 receives the signal of longitudinal inclination angle of vehicle body from the vehicle body longitudinal inclination angle sensor 6, and can use the vehicle body longitudinal inclination angle control mode to accomplish automatically and dynamically leveling operation of vehicle body against longitudinal inclination angle easily with the vehicle body inclination angle regulating units 17 described in the present invention. For example, when the mobile crane climbs a ramp, the vehicle body of the mobile crane in a state that the head part is higher and the rear part is lower, accordingly, the control unit 3 can control the vehicle body inclination angle regulating units 17 on the head part of the mobile crane, so as to control the cylinder rods in the front suspension oil cylinders 12 to retract, and thereby lower the head part of vehicle body of the mobile crane and keep the mobile crane in level state.

In addition, in the case that the automatically-leveling hydropneumatic suspension mechanism according to the present invention includes both the vehicle body transverse inclination angle sensor 1 and the vehicle body longitudinal inclination angle sensor 6 described above, those skilled in the art can conceive: if the vehicle body of the mobile crane has both transverse inclination angle and longitudinal inclination angle, the control unit 3 select appropriate vehicle body inclination angle control modes (e.g., select the transverse inclination angle control mode first, after the transverse inclination angle of vehicle body is eliminated by leveling operation, secondly select the longitudinal inclination angle control mode, so as to eliminate the longitudinal inclination angle), and thereby regulating the transverse inclination angle and longitudinal inclination angle of the mobile crane in combination; thus, the mobile crane will have automatically and dynamically leveling capability under various harsh road conditions; such a automatically-leveling hydropneumatic suspension mechanism can ensure safety of the mobile crane and avoid the over-turning risk when the mobile crane travels.

It is seen from above description: the automatically-leveling hydropneumatic suspension mechanism provided by the present invention can utilize the control unit 3 to select a specific control mode among predefined vehicle body inclination angle control modes according to the vehicle body inclination angle signal (preferably including the signal of axle load pressure on the suspension mechanism), so as to control the vehicle body inclination angle regulating units 17, and accomplish extension or retraction operation of the suspension oil cylinders 12 via the vehicle body inclination angle regulating units 17, and thereby the hydropneumatic suspension mechanism can keep the vehicle body in level state; then, the control unit 3 can continuously and automatically keep the vehicle body in a specific attitude or switch among vehicle body attitudes according to the signal after the leveling operation, and thereby achieve automatically and dynamically leveling of mobile engineering machines (e.g., mobile cranes) under different road conditions, especially under transverse slope road conditions. When the automatically-leveling hydropneumatic suspension mechanism according to the present invention keeps the vehicle body in a specific attitude or switch among vehicle body attitudes, preferably it utilizes a stable constant pressure oil source to supply power, so as to extrude the hydraulic oil out of the balancing oil cylinder 10 or seal the hydraulic oil in the balancing oil cylinder 10, and thereby keep fixed oil quantity in the hydropneumatic suspension mechanism and balance between left and right axle loads, to ensure smooth automatically-leveling operation of the mobile crane and effectively ensure safety of the mobile crane. The automatically-leveling hydropneumatic suspension mechanism according to the present invention effectively implements dynamically and automatically leveling capability of mobile engineering machines (e.g., mobile cranes) against different road conditions, especially dynamically and automatically leveling capability against transverse slopes; in addition, the automatically-leveling hydropneumatic suspension mechanism according to the present invention is easy to operate and logically reasonable; since all operations are accomplished automatically by the control unit 3, the automatically-leveling hydropneumatic suspension mechanism is safe and reliable to use, and significantly improves safety of vehicle running on longitudinal or transverse slope roads, and thereby can prevent severe accidents such as vehicle-overturning.

It is noted that the specific technical features described in above embodiments can be combined as required in any appropriate approach. However, any such combination shall be deemed as falling into the scope of disclosure of the present invention. Moreover, the different embodiments of the present invention can be combined freely as required, as long as the combinations don't deviate from the ideal and spirit of the present invention. However, such combinations shall also be deemed as falling into the scope of disclosure of the present invention.

While some preferred embodiments of the present invention are described above with reference to the accompanying drawings, the present invention is not limited to the details in those embodiments. Those skilled in the art can make modifications and variations to the technical solution of the present invention, without departing from the spirit of the present invention. However, all these modifications and variations shall be deemed as falling into the protected scope of the present invention. For example, in the embodiments of the present invention described above, the control unit 3 can also be a single chip microcomputer (SCM), instead of a PLC. The protected scope of the present invention shall be defined by the claims.

What is claimed is:

1. A vehicle body inclination angle regulating unit, wherein, it comprises a balancing oil cylinder, one chamber of the balancing oil cylinder being connected to an electric controlled switch valve by a hydraulic pipeline provided with a first one-way damper valve, the other chamber of the balancing oil cylinder being connected to a second one-way damper valve by a hydraulic pipeline provided with an electric controlled shutoff valve, so that the oil way to the other chamber of the balancing oil cylinder being selectively communicated or shut by the electric controlled shutoff valve.

2. The vehicle body inclination angle regulating unit according to claim 1, wherein, the balancing oil cylinder is a spring-return type oil cylinder, the chamber of the balancing oil cylinder connected to the electric controlled switch valve through the hydraulic pipeline via the first one-way damper valve is a spring chamber, and the other chamber of the balancing oil cylinder connected to the second one-way damper valve through the hydraulic pipeline via the electric controlled shutoff valve non-spring chamber.

3. The vehicle body inclination angle regulating unit according to claim 1, wherein, the electric controlled switch valve is a two-position three-way solenoid directional valve or two-position four-way solenoid directional valve, and the electric controlled shutoff valve is a two-position two-way solenoid directional valve or solenoid switch valve.

4. An automatically-leveling hydropneumatic suspension mechanism, comprising at least two pairs of suspension oil cylinders, each pair of which are respectively arranged on the left and right sides of a corresponding vehicle bridge, wherein, the automatically-leveling hydropneumatic suspension mechanism further comprises:
vehicle body inclination angle regulating units, each of the suspension oil cylinder being correspondingly connected with one of the vehicle body inclination angle regulating units, each of the vehicle body inclination angle regulating units designed to control a cylinder rod of the corresponding suspension oil cylinder to extend or retract;
a vehicle body transverse inclination angle sensor, designed to detect the transverse inclination angle of vehicle body; and
a control unit, which receives the signal of transverse inclination angle of vehicle body sent by the vehicle body transverse inclination angle sensor, and is connected with the vehicle body inclination angle regulating units through electric control circuit, the vehicle body inclination angle regulating unit comprises a balancing oil cylinder, one chamber of the balancing oil cylinder is connected to an oil tank and an oil source for leveling operation by a hydraulic pipeline provided with a first one-way damper valve and an electric controlled switch valve, and the electric controlled switch valve selectively controls the one chamber of the balancing oil cylinder to communicate with the oil tank or the oil source for leveling operation; and
the other chamber of the balancing oil cylinder is connected to a non-rod chamber of the corresponding suspension oil cylinder by a hydraulic pipeline provided with an electric controlled shutoff valve and a second one-way damper valve, and the electric controlled shutoff valve selectively communicates or shuts the communication pipeline between the other chamber of the balancing oil cylinder and the non-rod chamber of the corresponding suspension oil cylinder;
the control unit is connected to the oil source for leveling operation and the electric controlled switch valve and the electric controlled shutoff valve in the vehicle body inclination angle regulating unit through electric control circuits.

5. (canceled)

6. The automatically-leveling hydropneumatic suspension mechanism according to claim 4, wherein, the balancing oil cylinder is a spring-return type oil cylinder, the spring chamber of the balancing oil cylinder is connected to the oil tank and oil source for leveling operation through the hydraulic pipeline via the first one-way damper valve and the electric controlled switch valve, and the non-spring chamber of the balancing oil cylinder is connected to the non-rod chamber of the corresponding suspension oil cylinder through the hydraulic pipeline via the electric controlled shutoff valve and the second one-way damper valve.

7. The automatically-leveling hydropneumatic suspension mechanism according to claim 4, wherein, comprising two pairs of said suspension oil cylinders, in which one pair of said suspension oil cylinders are mounted on the left and right sides of front vehicle bridge, another pair of said suspension oil cylinders are mounted on the left and right sides of rear vehicle bridge.

8. The automatically-leveling hydropneumatic suspension mechanism according to claim 4, wherein, the oil source for leveling operation is a constant pressure oil source.

9. The automatically-leveling hydropneumatic suspension mechanism according to claim 4, wherein, further comprising a suspension mechanism pressure sensor, which detects the axle load pressure of the vehicle bridge and transmit an axle load pressure signal to the control unit.

10. The automatically-leveling hydropneumatic suspension mechanism according to claim 9, wherein, the suspension mechanism pressure sensor is an oil pressure sensor which is arranged in a detection port of the suspension oil cylinder or a suspension connected to the suspension oil cylinder.

11. The automatically-leveling hydropneumatic suspension mechanism according to claim 9, wherein, the suspension mechanism pressure sensor is a piezoelectric sensor which is arranged on the connection position between the suspension oil cylinder and vehicle frame.

12. The automatically-leveling hydropneumatic suspension mechanism according to claim 4, wherein, further comprising a vehicle body longitudinal inclination angle sensor which detects the longitudinal inclination angle of vehicle body, and transmits a signal of longitudinal inclination angle of vehicle body to the control unit.

13. The automatically-leveling hydropneumatic suspension mechanism according to claim 12, wherein, the upper end of the suspension oil cylinder is hinged to vehicle frame or the vehicle body, and the lower end of the suspension oil cylinder is hinged to the corresponding vehicle bridge.

14. The automatically-leveling hydropneumatic suspension mechanism according to claim 4, wherein, each pair of the suspension oil cylinders are respectively connected with matched left and right suspension valves and left and right hydraulic accumulators, the left suspension valve comprises a left suspension oil cylinder's rigid and elastic state control valve, and the right suspension valve comprises a right suspension oil cylinder's rigid and elastic state control valve,
the left suspension oil cylinder's rigid and elastic state control valve is arranged in the oil way between the oil port of the left hydraulic accumulator and the non-rod chamber of the suspension oil cylinder on one side, so as to selectively communicate or shut the oil way between the oil port of the left hydraulic accumulator and the non-rod chamber of the suspension oil cylinder on one side; and
the right suspension oil cylinder's rigid and elastic state control valve is arranged in the oil way between the oil port of the right hydraulic accumulator and the non-rod chamber of the suspension oil cylinder on the other side, so as to selectively communicate or shut the oil way between the oil port of the right hydraulic accumulator and the non-rod chamber of the suspension oil cylinder on the other side.

15. The automatically-leveling hydropneumatic suspension mechanism according to claim 14, wherein, the rod chamber of the suspension oil cylinder (12) on one side communicates with the oil port of the right hydraulic accumulator (11) through a pipeline, and the rod chamber of the suspension oil cylinder (12) on the other side communicates with the oil port of the left hydraulic accumulator (11) through a pipeline.

16. The automatically-leveling hydropneumatic suspension mechanism according to claim 14, wherein, the left suspension oil cylinder's rigid and elastic state control valve and the right suspension oil cylinder's rigid and elastic state control valve are respectively two-position two-way solenoid directional valves or solenoid switch valves.

17. The automatically-leveling hydropneumatic suspension mechanism according to claim 14, wherein, the left suspension valve further comprises a left suspension oil cylinder extension control valve and a left suspension oil cylinder retraction control valve, and the right suspension valve further comprises a right suspension oil cylinder extension control valve and a right suspension oil cylinder retraction control valve, wherein,
the left suspension oil cylinder extension control valve is arranged in the oil way between the pressure oil source and the non-rod chamber of the suspension oil cylinder on one side, so as to selectively communicate or shut the oil way between the pressure oil source and the non-rod chamber of the suspension oil cylinder on one side; the right suspension oil cylinder extension control valve is arranged in the oil way between the pressure oil source and the non-rod chamber of the suspension oil cylinder on the other side, so as to selectively communicate or shut the oil way between the pressure oil source and the non-rod chamber of the suspension oil cylinder on the other side;
The left suspension oil cylinder retraction control valve is arranged in the oil way between the oil tank and the non-rod chamber of the suspension oil cylinder on one side, so as to selectively communicate or shut the oil way between the oil tank and the non-rod chamber of the suspension oil cylinder on one side; the right suspension oil cylinder retraction control valve is arranged in the oil way between the oil tank and the non-rod chamber of the suspension oil cylinder on the other side, so as to selectively communicate or shut the oil way between the oil tank and the non-rod chamber of the suspension oil cylinder on the other side.

18. The automatically-leveling hydropneumatic suspension mechanism according to claim 17, wherein, the left and right suspension oil cylinder extension control valves and the left and right suspension oil cylinder retraction control valves are respectively two-position two-way solenoid directional valves or solenoid switch valves.

19. A mobile crane, wherein, comprising the automatically-leveling hydropneumatic suspension mechanism as described in claim 4.
